(19) United States
(12) Patent Application Publication
(10) Pub. No.: US 2016/0284245 A1
(43) Pub. Date: Sep. 29, 2016

(54) APPARATUS AND METHOD TO MOTIVATE PERFORMANCE

(71) Applicant: Martin Suarez, Tucson, AZ (US)

(72) Inventor: Martin Suarez, Tucson, AZ (US)

(21) Appl. No.: 14/670,154

(22) Filed: Mar. 26, 2015

(51) Int. Cl. G09B 29/00

(52) U.S. Cl. CPC G09B 29/001

(57) ABSTRACT

A method to motivate performance, which includes creating (N) tasks and determining an order of task performance, wherein (N) is greater than 1, creating a first visual theme for a status board, creating a graphic illustration for each of said (N) tasks, determining a visual appearance of a first routing from a first starting point to a first ending point, illustrating the first routing on said status board, disposing all (N) task illustrations along the first routing on the status board in said order of task performance, forming a moveable status indicator, setting (i) equal to 1; determining if an (i)th task recited on the status board has been completed, when the (i)th task recited on the status board has been completed, ascertaining if (i) equals (N), setting (i) equal to (i+1) when (i) does not equal (N), removeably attaching the moveable status indicator at the (i)th task illustration along the routing.

### FIELD OF THE INVENTION

This invention relates to an apparatus and a method using that apparatus to motivate performance of a plurality of desired tasks.

### SUMMARY OF THE INVENTION

A method to motivate performance is disclosed. The method includes collaboratively between a parent and child creating (N) tasks and determining an order of task performance, wherein (N) is greater than 1; collaboratively between a parent and child creating a first visual theme for a status board; based upon said first visual theme, creating a graphic illustration for each of said (N) tasks; based upon said visual theme, collaboratively between a parent and child creating determining a visual appearance of a first routing from a first starting point to a first ending point; illustrating said first routing on said status board; disposing all (N) task illustrations along said first routing on said status board in said order of task performance; based upon said visual theme, forming a moveable status indicator; setting (i) equal to 1; determining if an (i)th task recited on said status board has been completed; when said (i)th task recited on said status board has been completed, ascertaining if (i) equals (N); setting (i) equal to (i+1) when (i) does not equal (N); removeably attaching said moveable status indicator at the (i)th task illustration along said routing; repeating the determining, ascertaining, setting, and removeably attaching steps until (i) equals (N).

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates one embodiment of Applicant's status board 100;

FIG. 2 illustrates a status indicator 205 disposed at a starting point;

FIG. 3 illustrates a status indicator 205 positioned at a first stop 210 showing that the child has made her bed;

FIG. 4 illustrates a status indicator 205 positioned at a second stop 310 showing that the child has finished eating breakfast;

FIG. 5 illustrates a indicator 205 positioned at a third stop 410 showing that the child has finished brushing her teeth;

FIG. 6 illustrates a status indicator 205 positioned at a fourth stop 510 showing that the child has finished dressing;

FIG. 7 illustrates a status indicator 205 positioned at a fifth stop 610 showing that the child has finished brushing her hair;

FIG. 8 illustrates a status indicator 205 positioned at an ending point 120 thereby indicating that the child has successfully completed all required morning chores;

FIG. 9 is a flow chart summarizing Applicant's method to form Applicant's apparatus;

FIG. 10 illustrates a routing 1000;

FIG. 11A illustrates a status board 1100 which includes the routing 1000 disposed on a poster board in combination with a plurality of first attachment means;

FIG. 11B illustrates a status board 1102 which comprises status board 1100 in combination with a FREE TIME legend at ending point 120;

FIG. 12 illustrates a task sub-assembly 1200 which can be releaseably attached to status board 1100 or status board 1102;

FIG. 13 illustrates status board 1300 which includes status board 1100 and task sub-assembly 1200;

FIG. 14 illustrates a task sub-assembly 1400 which can be releaseably attached to status board 1100 or status board 1102;

FIG. 15 illustrates status board 1500 which includes status board 1100, task sub-assembly 1200, and task sub-assembly 1400;

FIG. 16 illustrates status board 1600 which includes status board 1100, task sub-assembly 1200, and task sub-assembly 1400, in a revised order along routing 1000;

FIG. 17 illustrates a task sub-assembly 1700 which can be releaseably attached to status board 1100 or status board 1102;

FIG. 18 illustrates a task sub-assembly 1800 which can be releaseably attached to status board 1100 or status board 1102;

FIG. 19 illustrates a task sub-assembly 1900 which can be releaseably attached to status board 1100 or status board 1102;

FIG. 20 illustrates status board 2000 which includes status board 1100, task sub-assembly 1200 removeably attached thereto, and task sub-assembly 1400 removeably attached thereto; task sub-assembly 1700 removeably attached thereto, and task sub-assembly 1800 removeably attached thereto, and task sub-assembly 1900 removeably attached thereto;

FIG. 21 illustrates a three-dimensional, moveable status indicator in the shape of a steam engine; and

FIG. 22 illustrates in cross-section a task sub-assembly substrate 1210 releaseably attached to Applicant's status board, where moveable status indicator 2100 is releaseably attached to a top portion of task sub-assembly substrate 1210.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow-chart included is generally set forth as a logical flow-chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicant's apparatus comprises a status board where that status board recites a starting point, an ending point, and a routing interconnecting the starting point and the ending point. Applicant's status board recites by illustration a plurality of tasks along the routing. After successfully completing a required task, a person manually moves a status indicator along the routing to a next task that must be successfully completed. After successfully completing each of the plurality of illustrated tasks, the status indicator reaches the ending point.

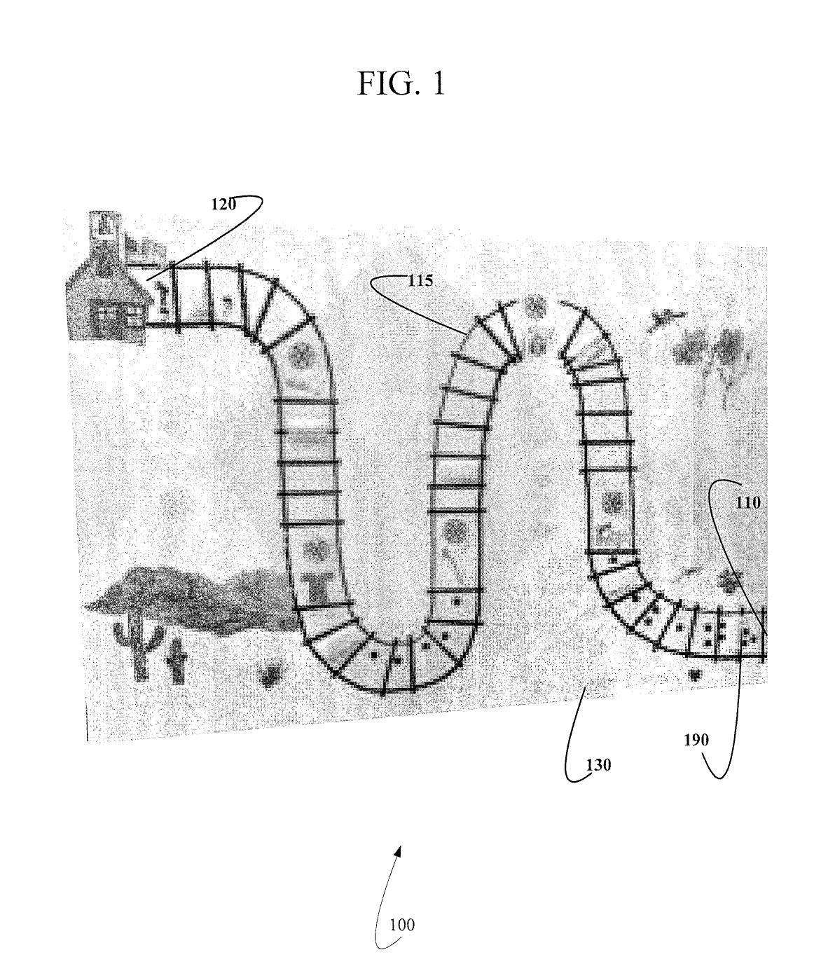

In the illustrated embodiment of FIG. 1, status board illustrates a routing 115 interconnecting a starting point 110 and an ending point 120. A first attachment means 190 is disposed on status board 100 at starting point 110. Further in the illustrated embodiment of FIG. 1, routing 115 is illustrated as a railroad track comprising a serpentine pattern leading from starting point 110 to ending point 120. As will be described hereinbelow, routing 115 requires that a total of five (5) morning chores be performed in order to successfully navigate the routing from start 110 to end 120. Each of those five chores is visually indicated by a “railroad crossing sign.”

The illustrated embodiments of FIGS. 1 through 8 should not be taken as limiting. Rather, FIGS. 1-8, and 10-20 illustrated embodiments of Applicant's apparatus and method. In other embodiments, Applicant's status board utilizes a different routing, such as and without limitation a highway, a hiking path, a swimming course, and the like.

Applicant's method using Applicant's apparatus is described hereinbelow with respect to a child completing morning chores. This description should not be taken as limiting. Applicant's apparatus and method can be utilized to motivate performance for a wide variety of tasks by persons of all ages.

In the illustrated embodiment of FIG. 1, status board 100 recites a first chore making the bed, a second chore eating breakfast, a third chore brushing the teeth, a fourth chore getting dressed, and a fifth chore brushing hair. Again, FIG. 1 should not be taken as limiting. In other embodiments, Applicant's status board recites fewer than five chores. In yet other embodiment, Applicant's status board recites greater than fire chores.

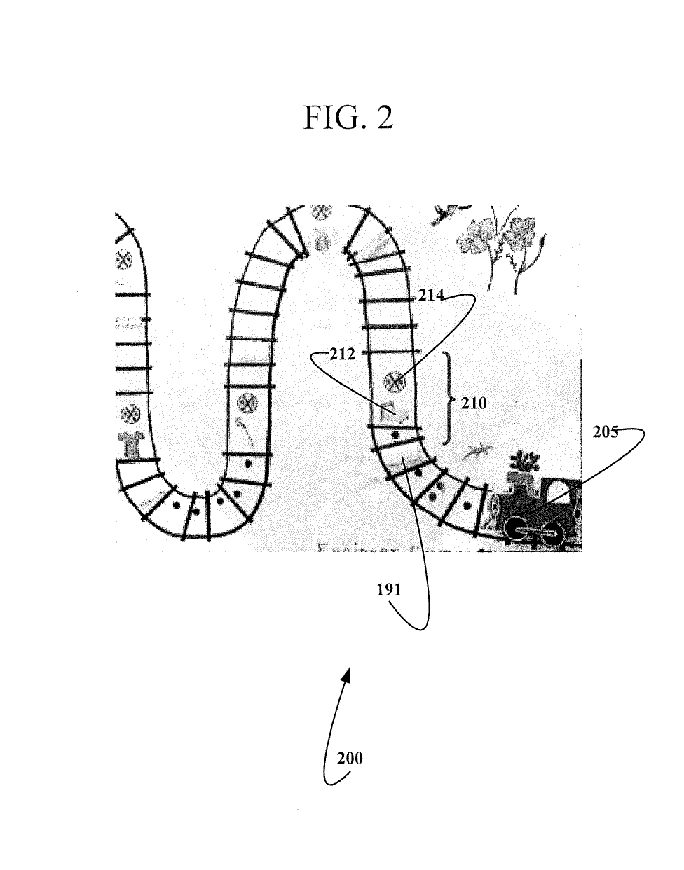

FIG. 2 illustrates a moveable status indicator 205 removeably attached to first attachment means 190 (FIG. 1). In the illustrated embodiment of FIG. 2, status indicator 205 comprises a locomotive engine. In other embodiments, the status indicator comprises, without limitation, a motor vehicle, a hiker, a swimmer, and the like.

In certain embodiments, first attachment means 190 comprises a plurality of “loop type” fasteners. In these embodiments, status indicator 205 comprises a plurality of “hook type” fasteners, wherein the status indicator can be removable attached to status board 100 by intermeshing the plurality of hook type fasteners with the plurality of loop type fasteners. In other embodiments, the first attachment means comprises, for example and without limitation, a set of cooperating magnets, a thumb tack, a pin, a paper clip, and the like.

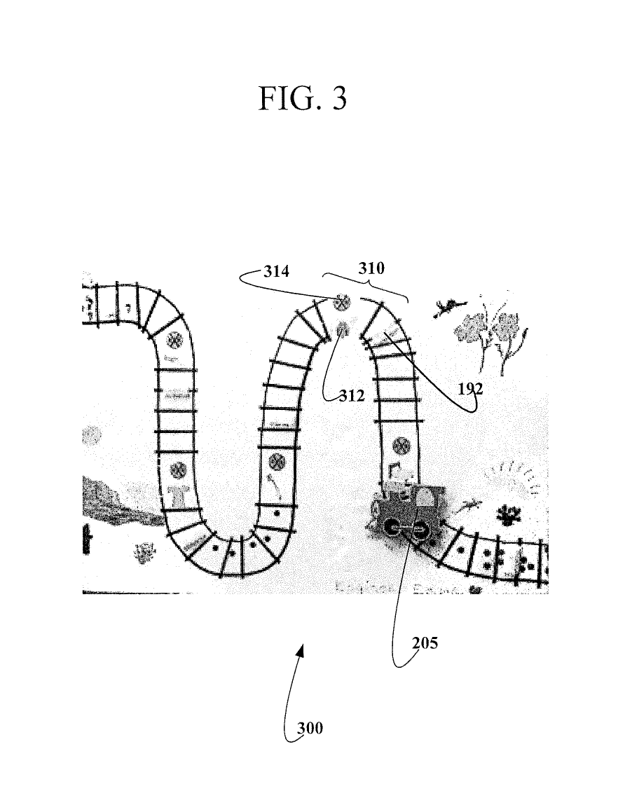

In the illustrated embodiment of FIG. 2, first stop 210 along routing 115 comprises a first attachment means 191, an illustration 212 of a bed, and a first railroad crossing sign 214. When the child makes her bed, she manually moves status indicator 205 from the first attachment means 190 at the starting position to first stop 210 by releaseably attaching status indicator 205 to first attachment means 191 (FIG. 2) as shown in FIG. 3.

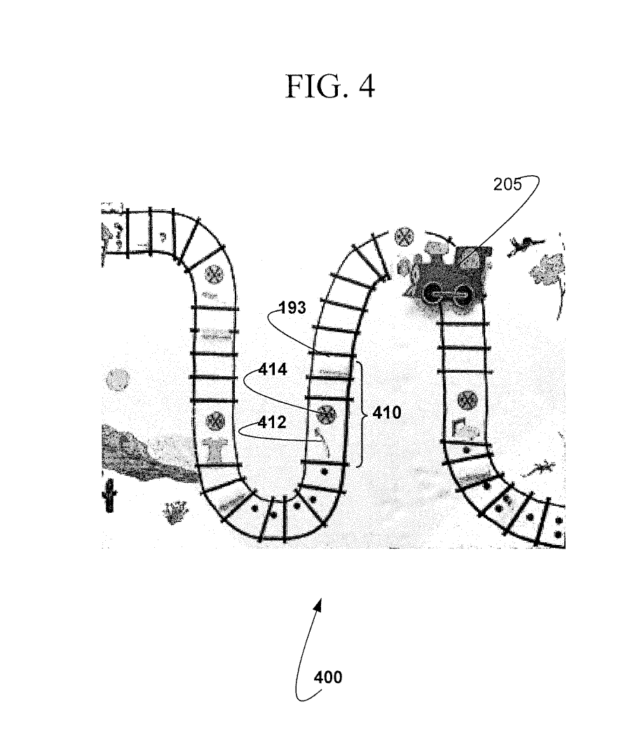

FIG. 3 further illustrates a second stop 310 along routing 115. Second stop 310 comprises a first attachment means 192, an illustration of a stack of waffles 312, and a second railroad crossing sign 314. When the child finishes breakfast, she manually moves status indicator 205 from the first attachment means 191 at first stop 210 to second stop 310 by releaseably attaching status indicator 205 to first attachment means 192 (FIG. 3) as shown in FIG. 4.

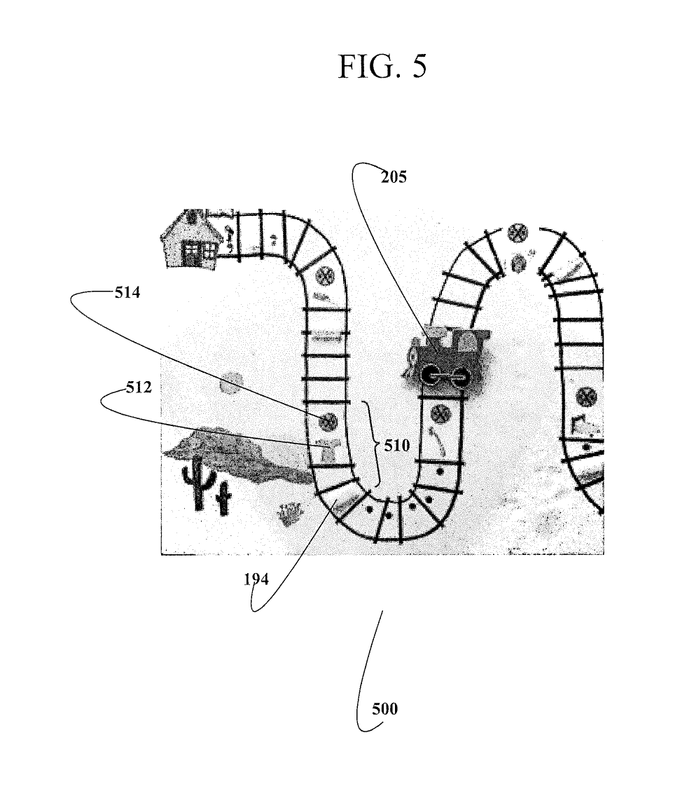

FIG. 4 further illustrates a third stop 410 along routing 115. Third stop 410 comprises a first attachment means 193, an illustration of a tooth brush 412, and a third railroad crossing sign 414. When the child finishes brushing her teeth, she manually moves status indicator 205 from the first attachment means 192 at second stop 310 to fourth stop 410 by releaseably attaching status indicator 205 to first attachment means 193 (FIG. 4) as shown in FIG. 5.

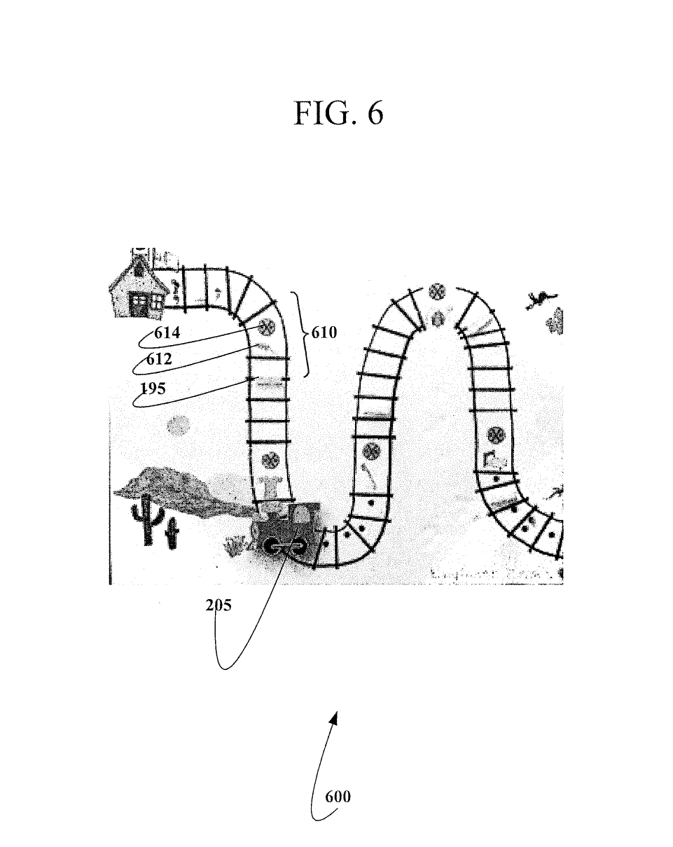

FIG. 5 further illustrates a fourth stop 510 along routing 115. Fourth stop 510 comprises a first attachment means 194, an illustration of a shirt 512, and a fourth railroad crossing sign 514. When the child finishes dressing, she manually moves status indicator 205 from the first attachment means 193 at third stop 410 to fourth stop 510 by releaseably attaching status indicator 205 to first attachment means 194 (FIG. 5) as shown in FIG. 6.

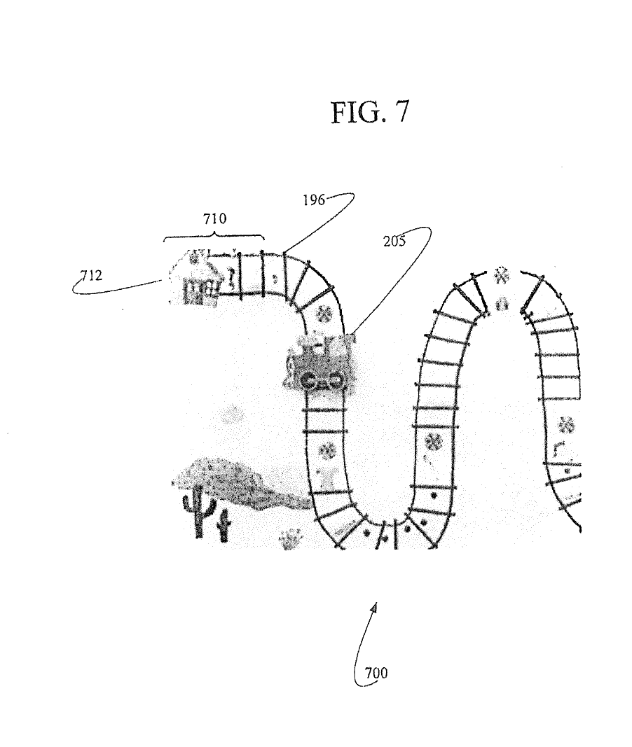

FIG. 6 further illustrates a fifth stop 610 along routing 115. Fifth stop 610 comprises a first attachment means 195, an illustration of a hair brush 612, and a fifth railroad crossing sign 614. When the child finishes brushing her teeth, she manually moves status indicator 205 from the first attachment means 194 at fourth stop 510 to fifth stop 610 by releaseably attaching status indicator 205 to first attachment means 195 (FIG. 6) as shown in FIG. 7.

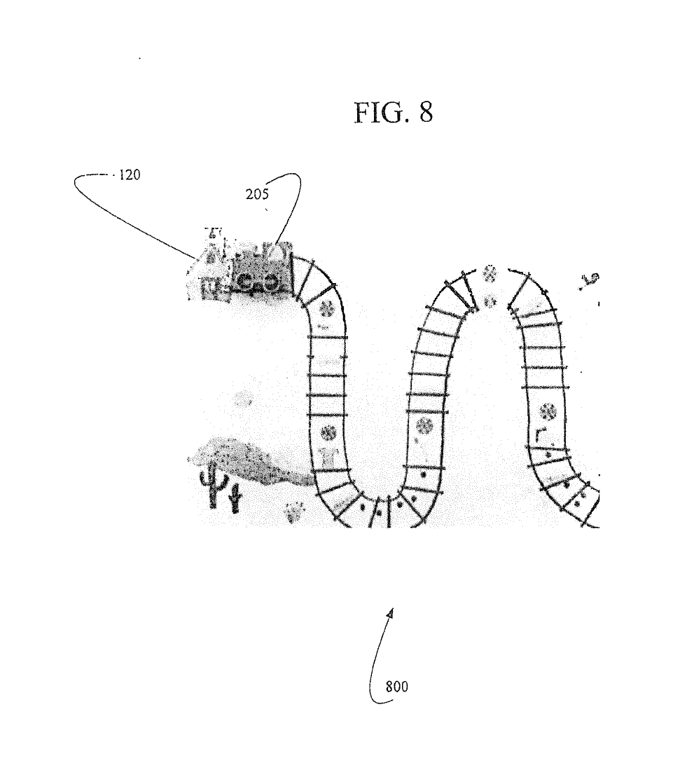

FIG. 7 further illustrates a final stop 710 along routing 115 at ending point 120 (FIG. 1). Final stop 710 comprises a first attachment means 196 and an illustration of a school 712. When the child finishes brushing her hair, she manually moves status indicator 205 from the first attachment means 195 at fifth stop 610 to final stop 710 by releaseably attaching status indicator 205 to first attachment means 196 to indicate that she has completed all required chores along routing 115, and is now has a certain amount of free time before departing for school, as shown in FIG. 8.

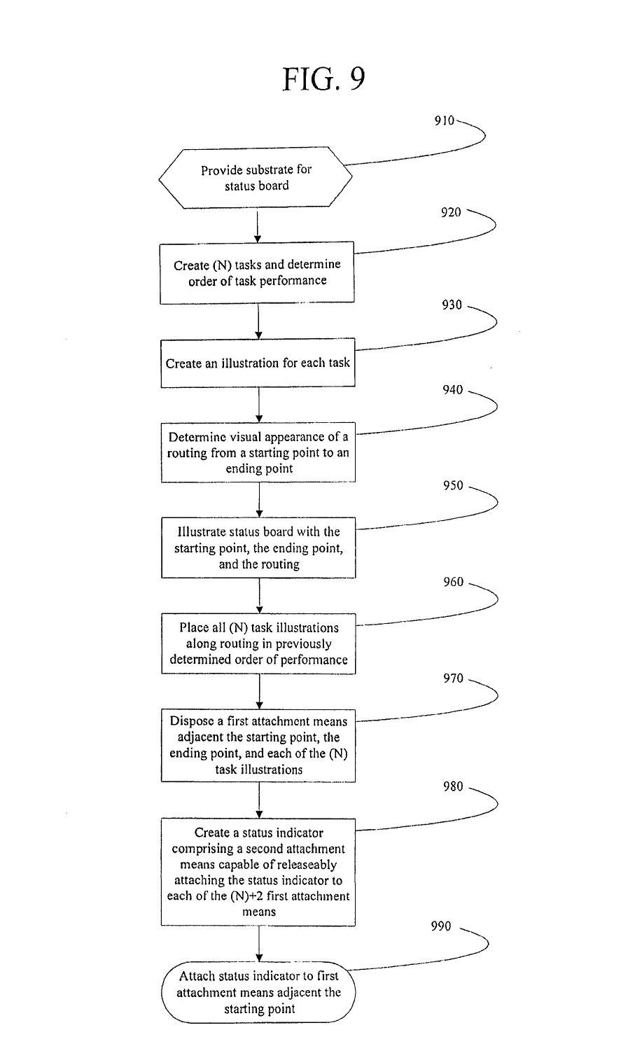

FIG. 9 summarizes Applicant's method to form his apparatus. In summary, Applicant's method

Referring now to FIG. 9, in step 910 the method provides a substrate for Applicant's status board. In certain embodiments, the substrate comprises a blank poster board.

In step 920, the method collaboratively defines (N) tasks and determines an order of performance for those (N) tasks, where (N) is greater than 1. For example, the status board of FIG. 1 recites five (5) tasks, including making the bed, eating breakfast, brushing the teeth, getting dressed, and brushing the hair.

In certain embodiments, the method collaboratively defines (N) morning tasks and determines an order of performance for those (N) tasks, where (N) is greater than 1. The method further collaboratively defines (M) evening tasks, where (M) is greater than 1. In these embodiments, the (N) morning tasks are recited on a first side of the status board of step 910, and the (M) evening tasks are recited on the opposite side of the status board of step 910.

In the morning, the status board is positioned such that the (N) morning tasks and the morning routing are displayed. In certain embodiments, when the child returns from school, the status board is positioned such that the (M) evening chores and the evening routing are displayed.

In certain embodiments, step 920 is a collaborative effort. For example and without limitation, in certain embodiments a parent and a child jointly define the (N) tasks and the order in which those (N) tasks should be performed. Applicant has found that such collaborative decision-making greatly facilitates the motivational success resulting from daily use of the jointly-designed status board. As described hereinbelow, in certain embodiments the order of the (N) tasks can be easily revised using separate task sub-assemblies.

In step 930, the method creates an illustration for each task. In step 940, the method determines a visual routing from a starting point to and ending point. For example, the status board of FIG. 1 shows the routing as a railroad track.

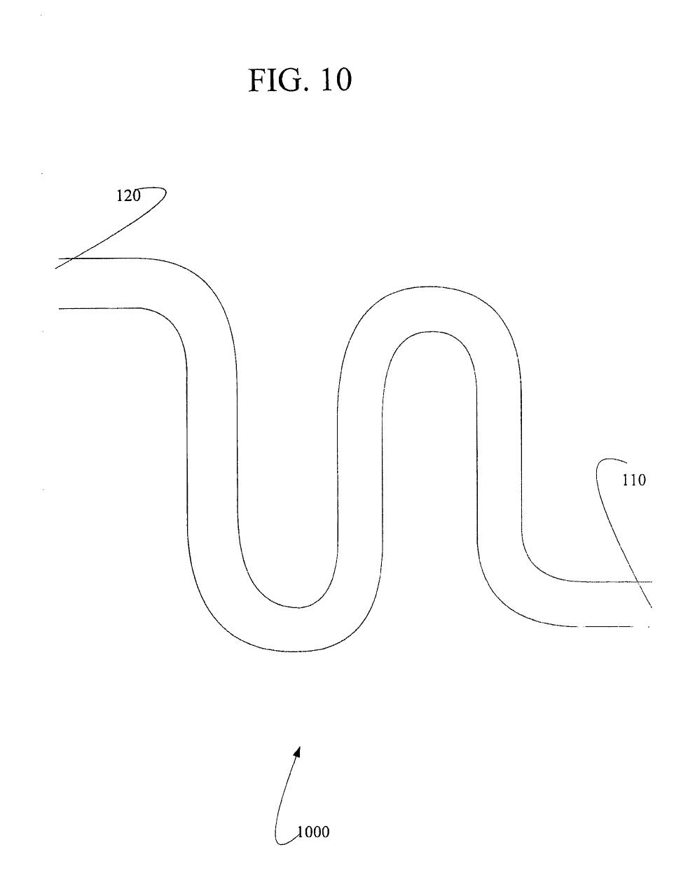

In step 950, the method illustrates the status board with the starting point, the ending point, and the routing. FIG. 10 shows a routing 1000 created for the status board of FIG. 1. In the illustrated embodiment of FIG. 10, routing 1000 includes a starting point 110 and an ending point 120.

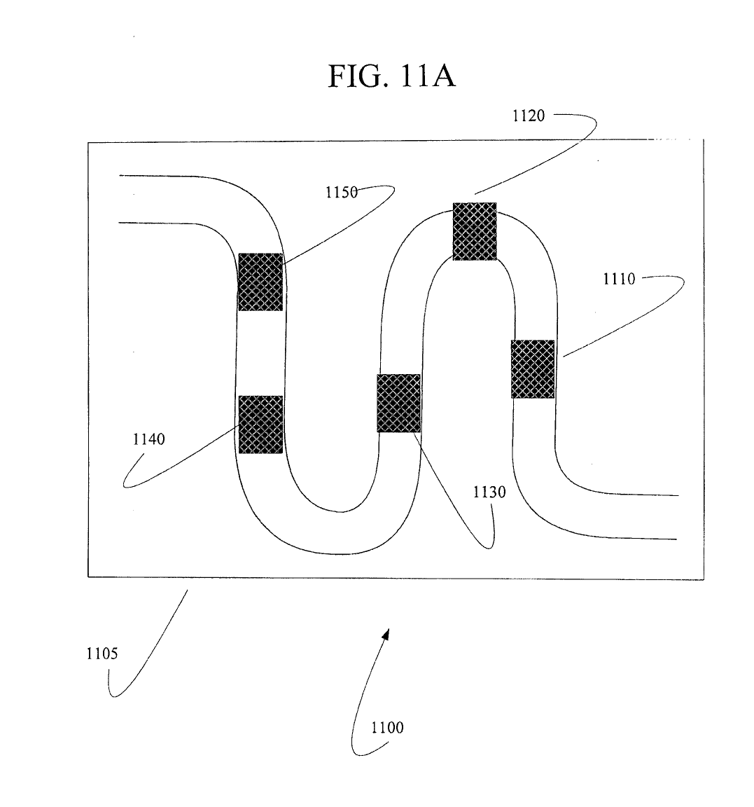

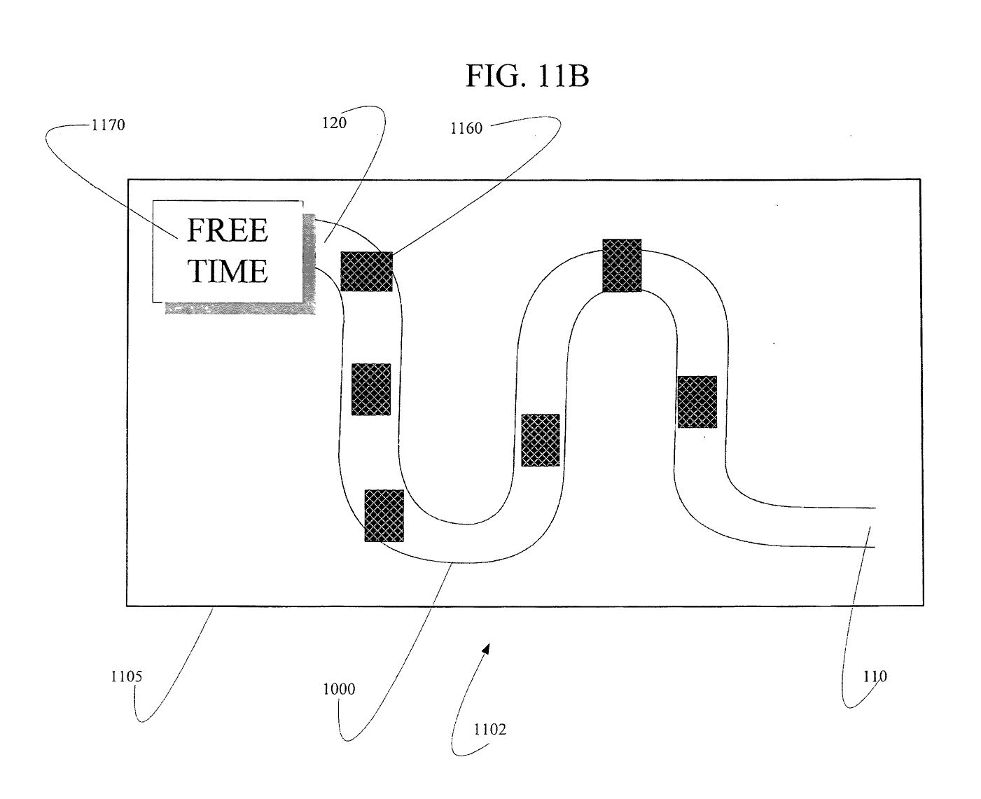

FIG. 11A shows routing 1000 disposed on a poster board 1105 to create a first status board 1100. In the illustrated embodiment of FIG. 11A, first attachment means 1110, 1120, 1130, 1140, and 1150, are shown disposed on status board 1100 along routing 1000.

FIG. 11B shows routing 1000 disposed on a poster board 1105 to create a status board 1102. In the illustrated embodiment of FIG. 11B, first attachment means 1110 (FIG. 11A), 1120 (FIG. 11A), 1130 (FIG. 11A), 1140 (FIG. 11A), 1150 (FIG. 11A), and 1160, are shown disposed on status board 1105 along routing 1000. When all five (5) identified tasks are complete, a status indicator, such as status indicator 205 (FIG. 2) can be removeably attached to first attachment means 1160 to indicate that all five (5) tasks have been completed. Status board 1105 further comprises a legend 1170 that reads “FREE TIME.”

A motivational aspect of status board 1102 is that the FREE TIME legend makes explicit that the more time efficiently the required tasks are completed, the greater the available free time will be. For example and without limitation, if a child must depart the home for school at 8:00 AM Monday through Friday. If the displayed (N) morning tasks are completed at 7:45 AM, then the child has fifteen (15) minutes of free time. On the there hand, if the displayed morning tasks are completed at 7:00 AM, then the child has sixty (60) minutes of free time.

In certain embodiments, when all the (M) evening chores have been completed the FREE TIME legend displayed on the evening status board makes explicit that the more time efficiently the required evening tasks are completed, the greater the available evening free time will be. For example and without limitation, if a child goes to bed at 9:00 PM, and all the displayed evening tasks are completed at 8:45 AM, then the child has fifteen (15) minutes of free time before bed. On the other hand, if the displayed evening tasks are completed at 8:00 PM, then the child has sixty (60) minutes of evening free time.

In step 960, the method places all (N) task illustrations along the routing on the status board, where the (N) tasks are arranged along the routing in the order determined in step 920.

In certain embodiments, each of the (N) task illustrations are disposed on (N) separate sub-assemblies. Those (N) task sub-assemblies are then releaseably disposed on status board 1000 using the (N) first attachment means 1110, 1120, 1130, 1140, and 1150, wherein (N) in this example is 5. In these embodiments, Applicant's method forms an (i)th task sub-assembly comprising an (i)th task sub-assembly substrate, disposes an (i)th task illustration on a first side of the (i)th task sub-assembly, removeably attaches the (i)th task sub-assembly on the first side of the status board along the first routing, determines if (i) equals (N), when (i) does not equal (N), setting (i) equal to (i+1), repeating the forming step, disposing step, removeably attaching step, and setting step, until (i) equals (N).

In certain embodiments, forming an (i)th task sub-assembly comprising an (i)th task sub-assembly substrate further comprises disposing an (i)th communication module in the (i)th task sub-assembly substrate, wherein the (i)th communication module comprises an (i)th processor, an (i)th non-transitory computer readable medium in communication with the (i)th processor, and (i)th computer readable program code encoded in the non-transitory computer readable medium.

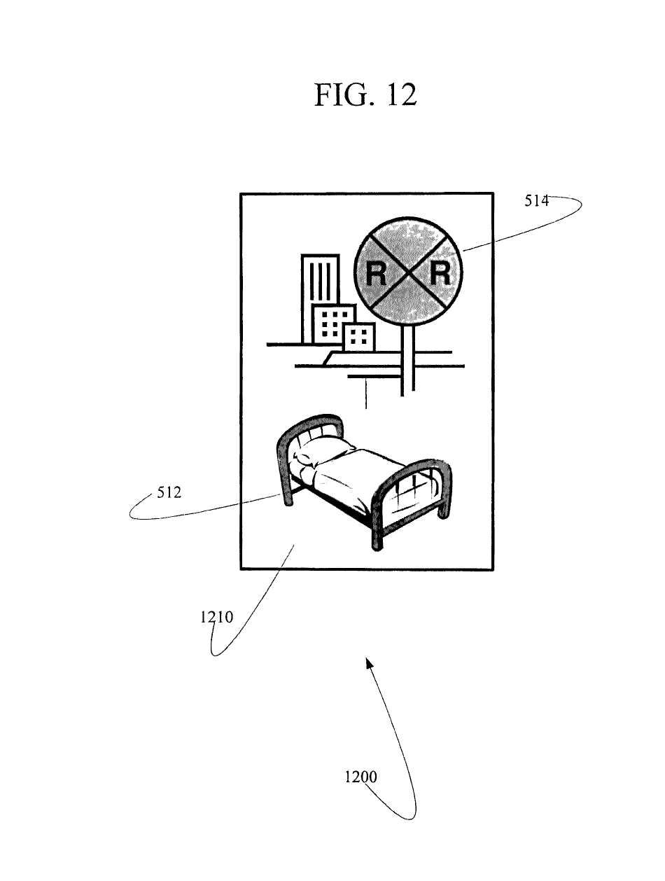

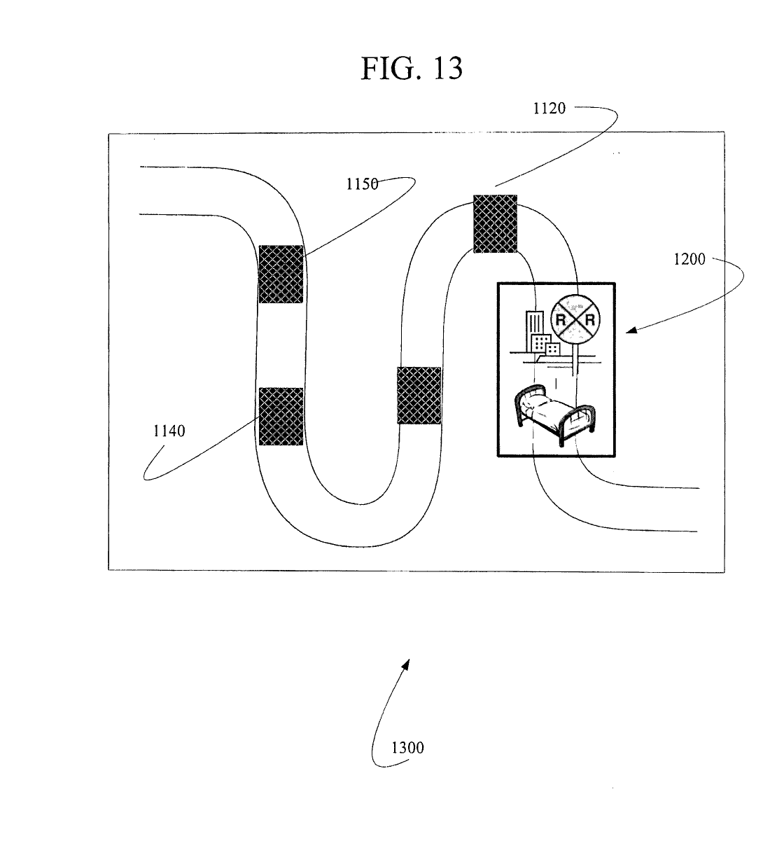

Referring now to FIG. 12, task sub-assembly 1200 comprises a task substrate 1210. Disposed on a first side of task substrate 1210 is a graphic image 212 of a made bed. Also disposed on the first side of task substrate 1210 is a graphic image of a railroad crossing sign 214. A second attachment means, as described hereinabove, is disposed on the second, opposing, side of task sub-assembly 1200. Referring now the FIG. 13, illustrated task sub-assembly 1200 is shown removeably disposed on status board 1100 (FIG. 11A) using first attachment means 1110 (FIG. 11A).

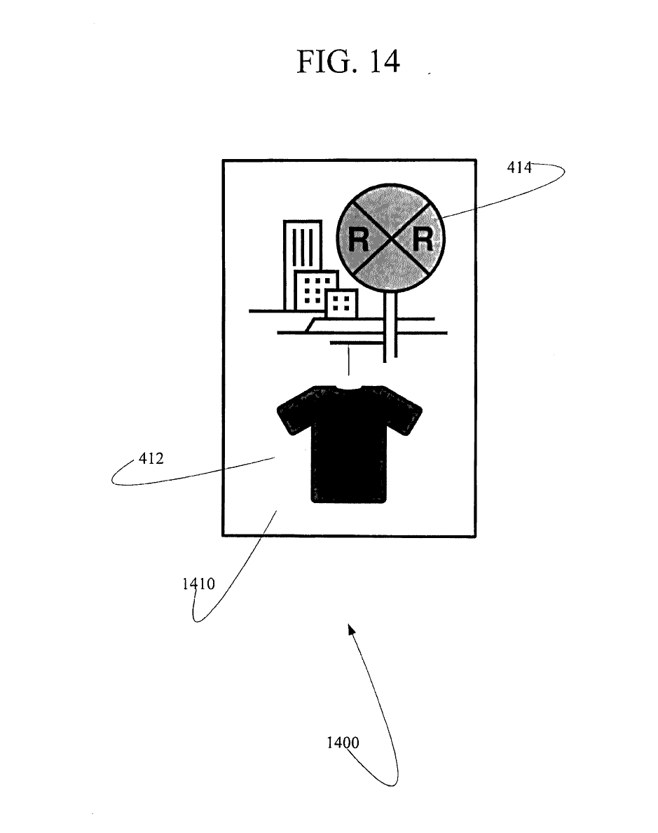

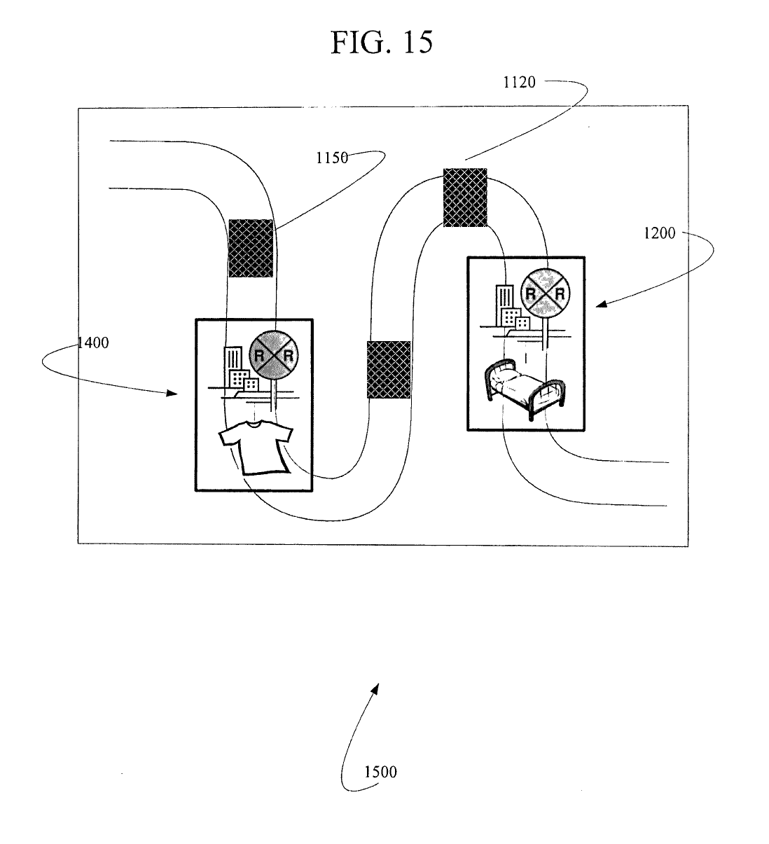

FIG. 14 shows a task sub-assembly 1400 comprises a task substrate 1210, a graphic image of a T-shirt 412, and a graphic image of a railroad crossing sign 414. A second attachment means, as described hereinabove, is disposed on the second, opposing, side of task sub-assembly 1400. Referring now the FIG. 15, task sub-assembly 1200 and task sub-assembly 1400 are shown removeably disposed on status board 1500 using first attachment means 1110 (FIG. 11A) and 1140 (FIG. 11A).

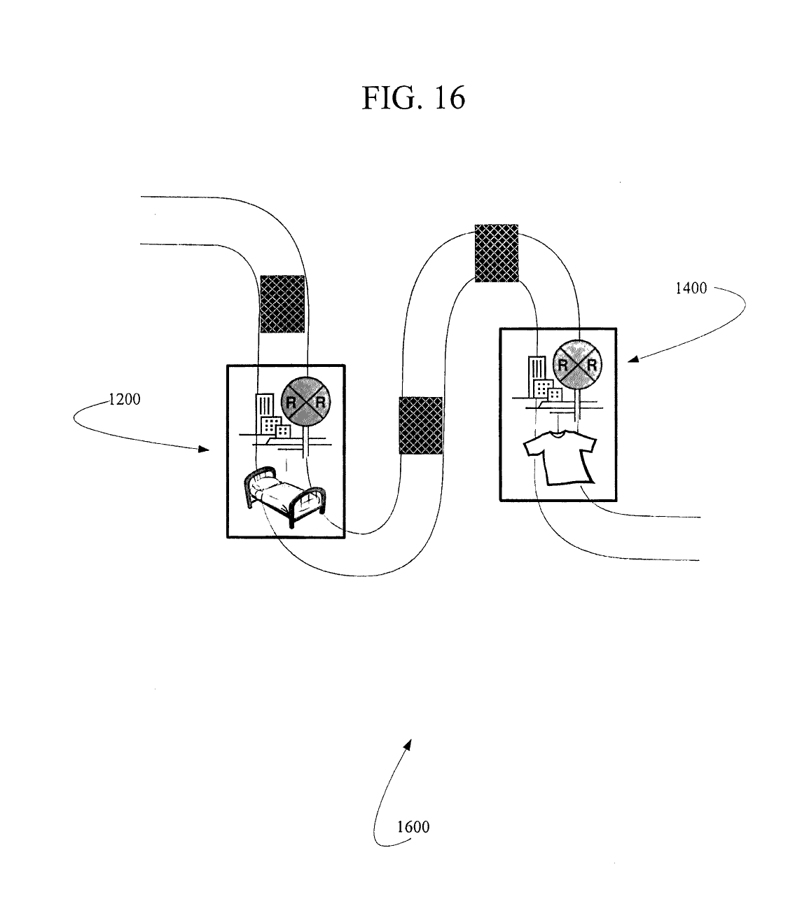

Because each task sub-assembly is releaseably attached to status board 1100, the order of the task can easily be revised. For example and referring now to FIG. 16, status board 1600 is shown wherein task sub-assembly 1400 becomes the first task on status board 1100, and task sub-assembly 1200 becomes the fourth task on status board 1100.

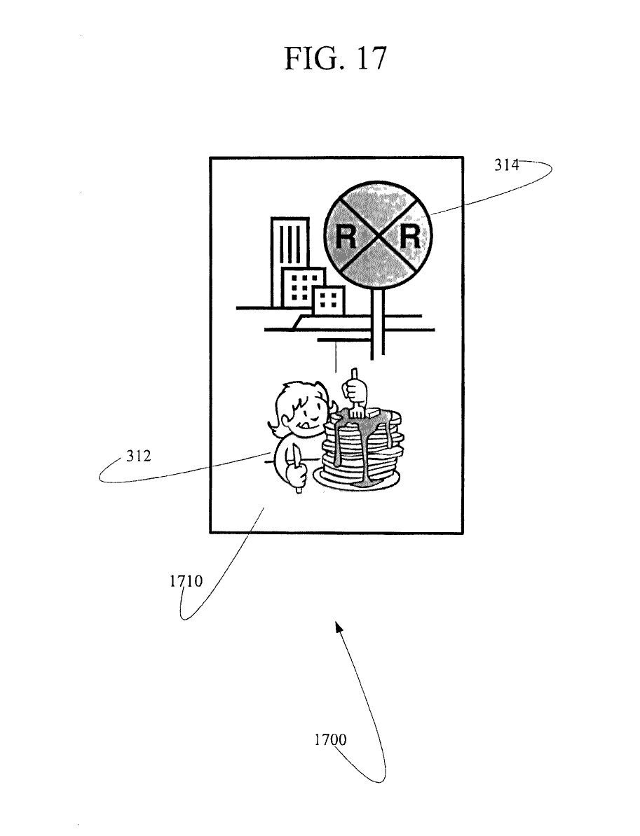

FIG. 17 shows a task sub-assembly 1700 comprising a task substrate 1710, a graphic image of a child eating a stack of pancakes 312, and a graphic image of a railroad crossing sign 314. A second attachment means, as described hereinabove, is disposed on the second, opposing, side of task sub-assembly 1700.

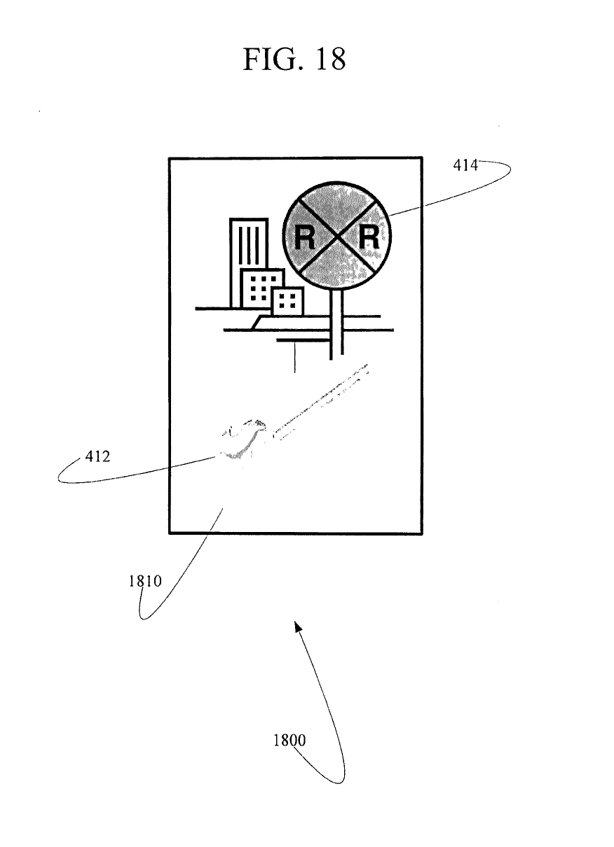

FIG. 18 shows a task sub-assembly 1800 comprising a task substrate 1810, a graphic image of a tooth brush 412, and a graphic image of a railroad crossing sign 414. A second attachment means, as described hereinabove, is disposed on the second, opposing, side of task sub-assembly 1800.

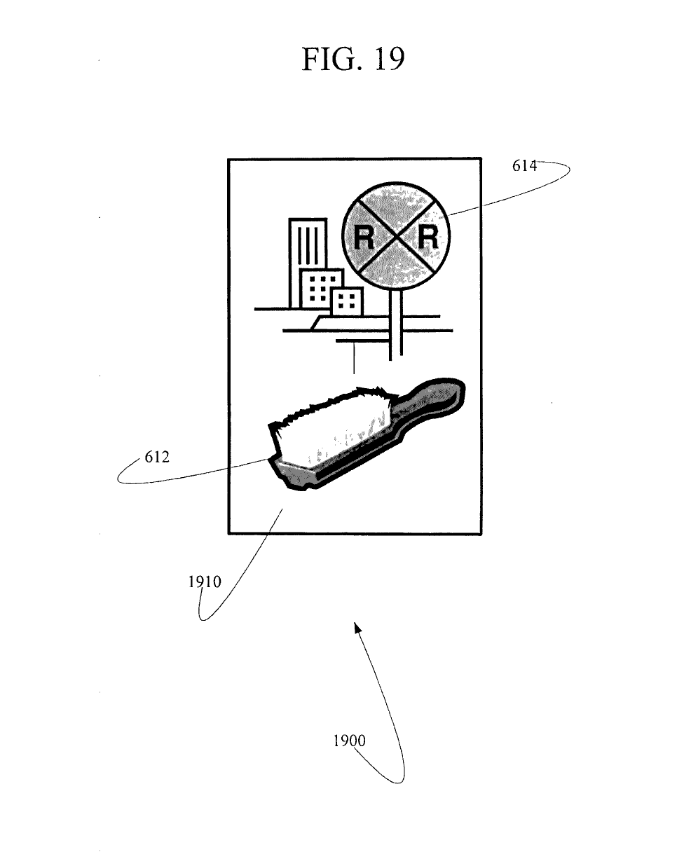

FIG. 19 shows a task sub-assembly 1900 comprising a task substrate 1910, a graphic image of a hair brush 612, and a graphic image of a railroad crossing sign 614. A second attachment means, as described hereinabove, is disposed on the second, opposing, side of task sub-assembly 1900.

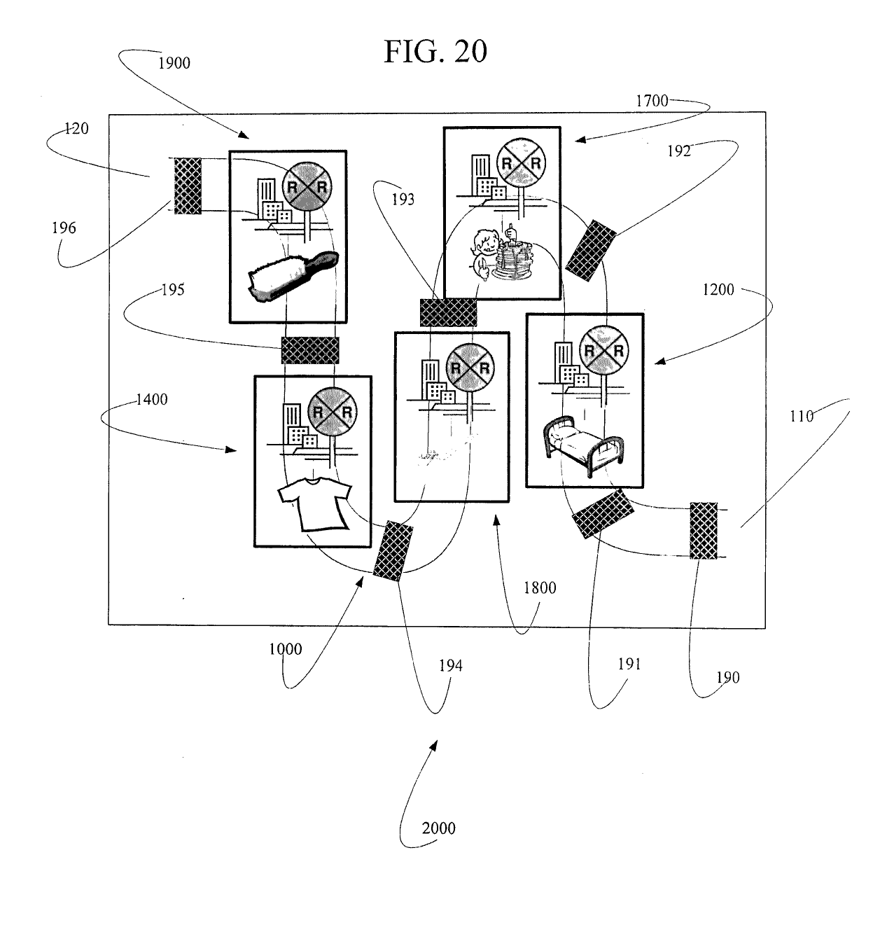

FIG. 20 shows status board 2000 which includes routing 1000, task-subassemblies 1200, 1700, 1800, 1400, and 1900, removeably attached to status board 2000 in a previously-agreed upon order. Status board 2000 further includes first attachment means 190, 191, 192, 193, 194, 195, and 196, allowing a status indicator, such as status indicator 205, to be progressively moved along routing 1000 as the various tasks graphically indicated on task-subassemblies 1200, 1700, 1800, 1400, and 1900, are successively completed.

In step 970, the method disposes a first attachment means adjacent the starting point, the ending point, and each of the (N) task illustrations.

In step 980, the method creates a status indicator comprising a second attachment means capable of releaseably attaching the status indicator to each of the (N)+2 first attachment means. In certain embodiments, step 980 further includes forming a moveable status indicator comprising a processor, status indicator communication module in communication with the processor, a speaker in communication with the processor, a plurality of light-emitting devices in communication with the processor, and one or more batteries in electrical contact with said status indicator communication module, processor, speaker, and plurality of light-emitting devices.

In step 990, the method attaches the status indicator to the first attachment means adjacent the starting point. Applicant's apparatus is now ready for use with Applicant's method described hereinabove.

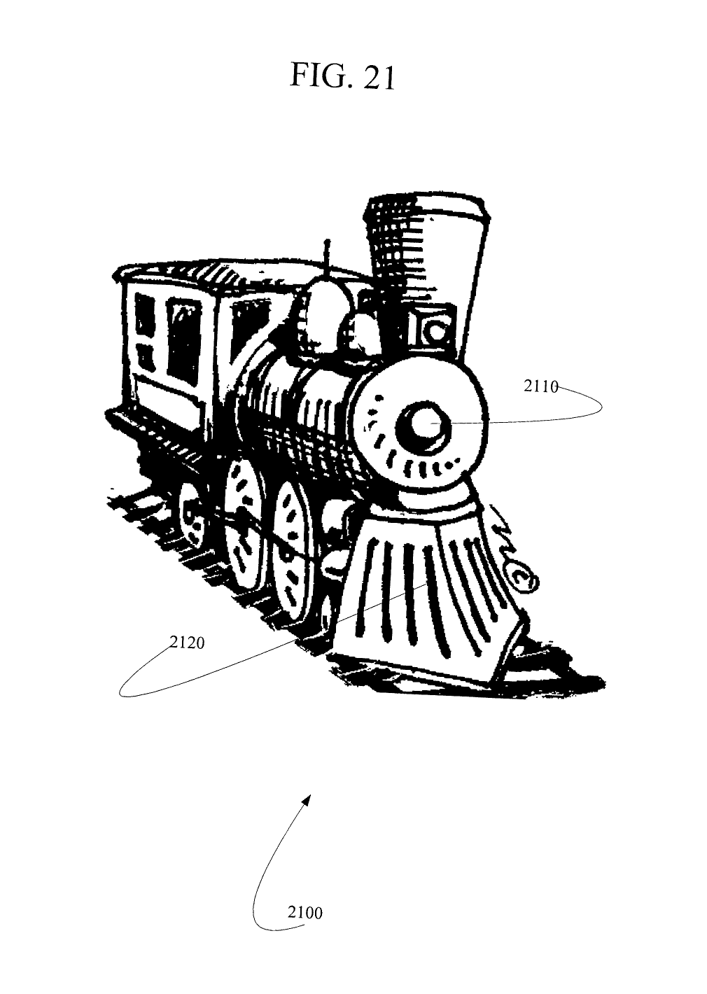

Referring now to FIG. 21, status indicator 2100 comprises a 3-D rendition of a railroad steam engine. Status indicator 2100 further comprises a light-emitting device 2110. In certain embodiments light-emitting device 2110 comprises one or more light emitting devices. In certain embodiments, light-emitting device 2110, when illuminated, displays a white light. In certain embodiments light-emitting device 2110, when illuminated, displays a green light. In certain embodiments, light-emitting device 2110, when illuminated, displays a red light.

In the illustrated embodiment of FIG. 21, status indicator 2100 further comprises a speaker 2120. In certain embodiments, status indicator 2100 comprises an internal processor 2240 (FIG. 12) and communication module 2245 (FIG. 12). In certain embodiments, status indicator wirelessly receives signals from a task sub-assembly disposed beneath that status indicator. In certain embodiments, those received signals cause status indicator 2100 to emit certain sounds, and/or display one or more colored lights from device 2110.

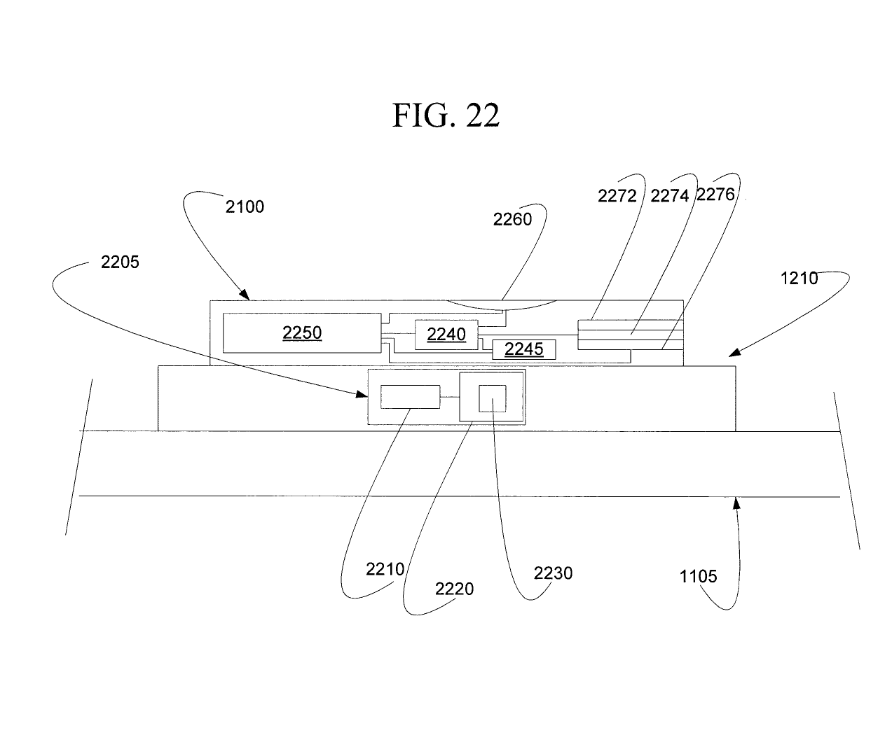

Referring now to FIG. 22, task sub-assembly substrate 1210 (FIG. 12) is shown removeably disposed on status board substrate 1105. Status indicator 2100 (FIG. 21) is shown removeably attached to the top of task sub-assembly substrate 1210.

FIG. 22 further shows a communication module 2205 disposed in task sub-assembly 1210. In certain embodiments, communication module 2205 comprises a processor 2210 in communication with a non-transitory computer readable medium 2220 and computer readable program code 2230 encoded in non-transitory computer readable medium 2220. In certain embodiments, processor 2210, non-transitory computer readable medium 2220, and computer readable program code 2230, comprise an integral assembly, such as and without limitation an ASIC.

In certain embodiments, communication module 2205 comprises an RFID “passive” communication device. In certain embodiments, communication module comprises a Blue Tooth “SMART” assembly which further comprises a battery power source.

In certain embodiments, communications module 2205 is “read/write” capable, where object-specific data can be written into the device by a user. Field programmable modules 2205 may be write-once, read-multiple; “blank” modules 2205 may be written with an electronic product code by the user.

In certain RFID embodiments, RFID tag 2205 comprises at least two parts: an integrated circuit 2210 for storing and processing information, modulating and demodulating a radio-frequency (RF) signal, collecting DC power from the incident reader signal, and other specialized functions; and an antenna for receiving and transmitting the signal. Certain information is stored in a non-volatile memory 2230.

In the illustrated embodiment of FIG. 22, status indicator 2100 comprises one or more batteries 2250, a communication module 2240, a speaker 2260, three (3) light emitting sources 2272, 2274, and 2276, each receiving power from power source 2250, and each interconnected to communication module 2240.

In certain embodiments, communication module 2245 comprises an RFID Reader. RFID Reader 2245 transmits an encoded radio signal to interrogate communication module 2205 embedded in the task sub-assembly disposed directly beneath the moveable status indicator 2100. In these embodiments, module 2205 receives the interrogation signal from module 2240, and then responds with its identification and other information.

In the event that signals are received by communication module 2245 from more than one module 2205 disposed in more than one task sub-assembly substrate, processor 2240 determines the strongest response signal, and selects that strongest signal as being provided by the nearest task sub-assembly substrate, i.e. the one directly beneath the moveable status indicator.

In certain embodiments, module 2240 includes an audio file. Module 2240 transmits this audio file when interrogated by module 2240. Module 2240 receives the audio file, and emits the encoded audio signal from speaker 2260. In certain embodiments, the emitted audible signal is in a parent's voice, and encourages a child to keep performing his/her tasks recited on the status board. Since each communication module embedded in a task sub-assembly substrate comprises a unique serial number, status indicator 2100, using module 2240, can discriminate among several embedded communication modules that might be within the range of the interrogation signal.

In certain embodiments, the information sent by a communication module, such as communication module 2205 embedded in a task sub-assembly substrate, upon interrogation by module 2245 embedded in a status indicator disposed above the task sub-assembly substrate, comprises instructions to turn on one of light emitting devices 2272, 2274, or 2276. In certain embodiments, light-emitting device 2272 emits a white light, which is projected outwardly from, for example and without limitation, from light 2110 (FIG. 21). In certain embodiments, light-emitting device 2274 emits a green light, which is projected outwardly from, for example and without limitation, from light 2110 (FIG. 21). In certain embodiments, light-emitting device 2276 emits a red light, which is projected outwardly from, for example and without limitation, from light 2110 (FIG. 21).

In certain embodiments, processor 2240 disposed in status indicator 2100 includes a timing device in communication with processor 2245. In certain embodiments, this timing device is integral with processor 2245.

In certain embodiments, Applicant's method further includes removeably attaching said moveable status indicator on said status board on top of said (i)th task sub-assembly substrate, interrogating the (i)th communication module by the status indicator communication module, wirelessly sending by the (i) communication module to the status indicator communication module an identification and information.

In certain embodiments, Applicant's method further includes wirelessly sending by an (i)th communication module to the status indicator communication module an audio file, and emitting an audio signal by the speaker.

In certain embodiments, Applicant's status indicator further comprises a timing device, and Applicant's method further includes starting the timing device when the moveable status indicator is removeably attached to the status board over an (i)th task sub-assembly substrate, receiving an (i)th identifier from the (i)th communication module, when the amount of time that the moveable status indicator remains over the (i)th task sub-assembly is less than an amount of time previously allocated for the (i)th task, Applicant's method illuminates a green light disposed on the moveable status indicator.

In certain embodiments, when the amount of time that the moveable status indicator remains over the (i)th task sub-assembly is less than an amount of time previously allocated for said (i)th task, Applicant's method emits by the speaker an audio signal announcing that the (i)th task is ahead of schedule.

In certain embodiments, when the amount of time that the moveable status indicator remains over the (i)th task sub-assembly is about equal to the amount of time previously allocated for the (i)th task, Applicant's method illuminates a white light disposed on the moveable status indicator.

In certain embodiments, when the amount of time that the moveable status indicator remains over the (i)th task sub-assembly is about equal to the amount of time previously allocated for the (i)th task, Applicant's method emits by t speaker an audio signal announcing that the (i)th task is just on schedule.

In certain embodiments, Applicant's status board and moveable status indicator utilize a wireless system comprising a separate and uniquely-identifiable communication module disposed in one or more of the task sub-assembly substrates. An interrogator or reader is disposed in the status indicator, wherein the interrogator sends a signal to a communication module disposed in a task subassembly, and wherein that interrogator receives a response from that task subassembly. In certain embodiments the response comprises an audio file. In certain embodiments the response comprises an instruction that causes a processor disposed in the status indicator to cause a device to illuminate.

In these embodiments, processor 2245 maintains a running time indicating the length of time that status indicator has been disposed on a certain task sub-assembly. When the elapsed time that status indicator 2100 remains over a given task is less than the amount of time previously allotted for that task, light 2110 on status indicator 2100 emits a green light. When the amount of time that the status indicator 2100 remains over a given task is about equal to the amount of time previously allotted for that task, light 2110 on status indicator 2100 emits a white light. When the elapsed time that status indicator 2100 remains over a given task is greater than the amount of time previously allotted for that task, light 2110 on status indicator 2100 emits a flashing red light.

In certain of these “timing” embodiments, when the elapsed time that status indicator 2100 remains over a given task is less than the amount of time previously allotted for that task, an audio file announcing that the child is “ahead of schedule” is selected by processor 2245. When the amount of time that the status indicator 2100 remains over a given task is about equal to the amount of time previously allotted for that task, an audio file announcing that the child is “just on schedule” is selected by processor 2245. When the amount of time that the status indicator 2100 remains over a given task is greater than the amount of time previously allotted for that task, an audio file announcing that the child is “behind schedule” is selected by processor 2245.

While the preferred embodiments of the present invention have been illustrated in detail, it should be apparent that modifications and adaptations to those embodiments may occur to one skilled in the art without departing from the scope of the present invention.

I claim:

1. A method to motivate performance, comprising:
creating (N) tasks and determining an order of task performance, wherein (N) is greater than 1;
creating a first visual theme for a status board;
based upon said first visual theme, creating a graphic illustration for each of said (N) tasks;
based upon said visual theme, determining a visual appearance of a first routing from a first starting point to a first ending point;
illustrating said first routing on said status board;
disposing all (N) task illustrations along said first routing on said status board in said order of task performance;
based upon said visual theme, forming a moveable status indicator;
setting (i) equal to 1;
determining if an (i)th task recited on said status board has been completed;
when said (i)th task recited on said status board has been completed, ascertaining if (i) equals (N);
setting (i) equal to (i+1) when (i) does not equal (N);
removeably attaching said moveable status indicator at the (i)th task illustration along said routing;
repeating said determining, ascertaining, setting, and removeably attaching steps until (i) equals (N).

2. The method of claim 1, wherein said creating (N) tasks further comprises creating (N) tasks collaboratively by a child and a parent of the child.

3. The method of claim 2, wherein said determining an order of task performance further comprises determining an order of task performance collaboratively by a child and a parent of the child.

4. The method of claim 3, wherein said creating a visual theme for a status board further comprises creating a visual theme for a status board collaboratively by a child and a parent of the child.

5. The method of claim 1, wherein said disposing all (N) task illustrations along said first routing on said status board in said order of task performance further comprises:
forming an (i)th task sub-assembly comprising an (i)th task sub-assembly substrate;
disposing an (i)th task illustration on a first side of said (i)th task sub-assembly;
removeably attaching said (i)th task sub-assembly on said first side of said status board along said first routing;
determining if (i) equals (N);
when (i) does not equal (N), setting (i) equal to (i+1);
repeating said forming, disposing, removeably attaching, and setting steps until (i) equals (N).

6. The method of claim 5, wherein said forming an (i)th task sub-assembly comprising an (i)th task sub-assembly substrate further comprises disposing an (i)th communication module in said (i)th task sub-assembly substrate, wherein said (i)th communication module comprises an (i)th processor, an (i)th non-transitory computer readable medium in communication with said (i)th processor, (i)th computer readable program code encoded in said non-transitory computer readable medium.

7. The method of claim 6, wherein said forming a moveable status indicator further comprises forming a moveable status indicator comprising a status indicator communication module and one or more batteries in electrical contact with said status indicator communication module.

8. The method of claim 7, further comprising:
removeably attaching said moveable status indicator on said status board on top of said (i)th task sub-assembly substrate;
interrogating said (i)th communication module by said status indicator communication module;
wirelessly sending by said (i) communication module to said status indicator communication module an identification and information.

9. The method of claim 8, wherein said moveable status indicator further comprises an audio speaker, and wherein an audio file is encoded in said (i)th non-transitory computer readable medium, the method further comprising:
wirelessly sending by said (i)th communication module to said status indicator communication module said audio file;
emitting an audio signal by said speaker.

10. The method of claim 10, wherein said audio signal comprises a parent's voice encouraging a child to keep performing his/her tasks recited on said status board.

11. The method of claim 8, wherein said moveable status indicator further comprises a plurality of light emitting devices and a timing device, said method further comprising:
starting said timing device when said moveable status indicator is removeably attached to said status board over an (i)th task sub-assembly substrate;
receiving said (i)th identifier from said (i)th communication module;
when the amount of time that said moveable status indicator remains over said (i)th task sub-assembly is less than an amount of time previously allocated for said (i)th task, illuminating a green light disposed on said moveable status indicator.

12. The method of claim 11, further comprising when the amount of time that said moveable status indicator remains over said (i)th task sub-assembly is less than an amount of time previously allocated for said (i)th task, emitting by said speaker an audio signal announcing that the (i)th task is ahead of schedule.

13. The method of claim 11, further comprising when the amount of time that said moveable status indicator remains over said (i)th task sub-assembly is about equal to said amount of time previously allocated for said (i)th task, illuminating a white light disposed on said moveable status indicator.

14. The method of claim 13, further comprising when the amount of time that said moveable status indicator remains over said (i)th task sub-assembly is about equal to said amount of time previously allocated for said (i)th task, emitting by said speaker an audio signal announcing that the (i)th task is just on schedule.

15. The method of claim 13, further comprising when the amount of time that said moveable status indicator remains over said (i)th task sub-assembly is greater than said amount of time previously allocated for said (i)th task, flashing a red light disposed on said moveable status indicator.

16. The method of claim 15, further comprising when the amount of time that said moveable status indicator remains over said (i)th task sub-assembly is greater than said amount of time previously allocated for said (i)th task, emitting by said speaker an audio signal announcing that the (i)th task is behind schedule.

17. The method of claim 1, wherein:
said (N) tasks comprise tasks that must be completed each morning;
said illustrating said first routing on said status board comprises illustrating said first routing on a first side of said status board;
said method further comprising:
creating (M) tasks that must be completed each evening and determining an order of task performance, wherein (M) is greater than 1;
creating a second visual theme for said status board;
based upon said second visual theme, creating a graphic illustration for each of said (M) tasks;
based upon said visual theme, determining a visual appearance of a second routing from a second starting point to a second ending point;
illustrating said second routing on a second side of said status board;
disposing all (M) task illustrations along said second routing on said status board in said order of task performance;
based upon said second visual theme, forming a second moveable status indicator;
setting (j) equal to 1;
determining if a (j)th task recited on said status board has been completed;
when said (j)th task recited on said second side of said status board has been completed, ascertaining if (j) equals (M);
setting (j) equal to (j+1) when (j) does not equal (M);
removeably attaching said second moveable status indicator at the (j)th task illustration along said second routing;
repeating said determining, ascertaining, setting, and removeably attaching steps until (j) equals (M).

18. The method of claim 17, wherein said creating (M) tasks further comprises creating (M) tasks collaboratively by a child and a parent of the child.

19. The method of claim 18, wherein said determining an order of task performance further comprises determining an order of task performance collaboratively by a child and a parent of the child.

20. The method of claim 19, wherein said creating a second visual theme for a status board further comprises creating a second visual theme for a status board collaboratively by a child and a parent of the child.
